(19) United States
(12) Patent Application Publication
(10) Pub. No.: US 2008/0032722 A1
(43) Pub. Date: Feb. 7, 2008

(54) METHOD FOR RECEIVING MESSAGES AND MOBILE STATION USING THE SAME

(75) Inventors: Che-Chih Chiang, Hsinchu City (TW); Chih-Hsin Lee, Kinmen County (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/834,515

(22) Filed: Aug. 6, 2007

(30) Foreign Application Priority Data
Aug. 7, 2006 (TW) 95128887

(51) Int. Cl. H04N 7/10

(52) U.S. Cl. 455/466

(57) ABSTRACT

A method for receiving messages includes the following steps. First, a base station broadcasts a scheduling message, which has an updated bit in a scheduling period. Next, the base station broadcasts a plurality of broadcasting messages. Finally, a mobile station receives the scheduling message and determines to receive the broadcasting messages selectively in the scheduling period according to the updated bit.

This application claims the benefit of Taiwan application Serial No. 95128887, filed Aug. 7, 2006, the subject matter of which is incorporated herein by reference.

### BACKGROUND OF THE INVENTION

1. Field of the Invention

The invention relates in general to a method for receiving messages and a mobile station using the same, and more particularly to a method for receiving broadcasting messages and a mobile station using the same, in which power consumption is small and the standby time is short.

2. Description of the Related Art

A short message service cell broadcast (SMSCB) is widely provided by various system service providers. In the SMSCB, a base station controller (BSC) transmits a base station broadcasting message to a base station, which transmits the base station broadcasting message to a mobile station (MS). FIG. 1 (Prior Art) is a schematic illustration showing a conventional base station broadcasting message 100. The base station broadcasting message 100 is transmitted from the base station to the mobile station, and has the size of 88 octets. The base station broadcasting message 100 includes six pieces of system information SI with the size of 6 octets and eighty two pieces of data information DI with the size of 82 octets. The six pieces of system information SI include a serial number and a message identifier. Each of the serial number and the message identifier occupies the space with the size of two octets. FIG. 2 (Prior Art) is a schematic illustration showing the base station broadcasting message 100 being divided and transmitted. As shown in FIG. 2, when the base station broadcasting message 100 is being transmitted, the base station divides the base station broadcasting message 100 into first to fourth broadcasting messages 101 to 104, each of which has the size of 22 octets. The first to fourth broadcasting messages 101 to 104 are sequentially received by the mobile station, wherein the first broadcasting message 101 includes the six pieces of system information SI.

In order to prevent the mobile station from receiving all the broadcasting messages, which include the broadcasting messages the user is interested and not interested and are transmitted from the base station. To save the power consumption of the mobile station, the base station transmits a scheduling message in advance to provide the information of the broadcasting messages, that will be transmitted immediately, to the mobile station. The mobile station may only receive the broadcasting messages the user is interested according to the scheduling message. The scheduling message includes information of the broadcasting messages that will be continuously transmitted immediately. The time length covered by the broadcasting messages is the scheduling period of the scheduling message. The scheduling message includes a serial number, a new message bitmap and a new message description, which has a message identifier.

FIG. 3 (Prior Art) is a flow chart showing a conventional method for receiving the messages, wherein the mobile station stores a plurality of original broadcasting messages. First, in step 302, the mobile station receives the scheduling message transmitted from the base station. Next, in step 304, the mobile station checks whether the new message bitmap in the scheduling message is 1. When the new message bitmap is 1, the procedure enters step 306, in which the mobile station checks the new message description in the scheduling message to judge whether the broadcasting messages to be subsequently transmitted are transmitted from the base station at the first time in the scheduling period. If the broadcasting messages are transmitted at the first time in the scheduling period, the mobile station checks the message identifier in the new message description in step 308 to judge whether the user is interested in the broadcasting messages or not.

When the user is interested in the broadcasting messages, the mobile station receives a first broadcasting message of the broadcasting messages, and judges whether the broadcasting messages have been updated according to the serial number of the first broadcasting message in step 310. When the serial number is not changed, it represents that the broadcasting messages have not been updated, so the mobile station drops out the received first broadcasting message and then the procedure ends. When the mobile station finds that the serial number has been changed, it represents that the broadcasting messages have been updated, so the mobile station receives the remainder of the broadcasting messages to combine the first broadcasting message with the remainder of the broadcasting messages into a complete base station broadcasting message.

In the method for receiving the messages, the mobile station checks the new message description of the scheduling message to judge that the subsequently transmitted broadcasting messages are transmitted from the base station at the first time in the scheduling period and received the broadcasting messages in step 306. However, the mobile station may receive the original broadcasting messages, which are transmitted from the base station to the mobile station in the previous scheduling period. Although the original broadcasting messages are transmitted at the first time in the scheduling period, the mobile station has received the original broadcasting messages in the previous scheduling period, so the broadcasting messages is still in the non-updated state for the mobile station. The mobile station cannot know the received messages are the original broadcasting messages until step 310 by receiving the first broadcasting message and judging that the serial number is not updated. At this time, the mobile station has received the first broadcasting message and has to drop out the first broadcasting message again, so the energy is wasted, and the mobile station has the longer standby time.

### SUMMARY OF THE INVENTION

The invention is directed to a method for receiving messages and a mobile station using the same, wherein an updated bit is added to a scheduling message, and the updated bit provides the mobile station more detailed information of continuously transmitting broadcasting messages in the following scheduling period. Thus, the mobile station determines whether to receive the broadcasting messages or not to reduce the power consumption and shorten the standby time.

According to a first aspect of the present invention, a method for receiving messages is provided. The method includes the following steps. First, a base station broadcasts a scheduling message having an updated bit in a scheduling period. Next, the base station broadcasts a plurality of broadcasting messages. Finally, a mobile station receives the scheduling message and determines to selectively receive the plurality of broadcasting messages in the scheduling period according to the updated bit.

According to a second aspect of the present invention, a mobile station for receiving messages broadcasted from a base station is provided. The base station broadcasts a scheduling message and a plurality of broadcasting messages. The scheduling message has an updated bit in a scheduling period. The mobile station includes a storing unit, a receiving unit and a control unit. The storing unit stores a plurality of original broadcasting messages. The receiving unit receives the scheduling message. The control unit controls the receiving unit to selectively receive the plurality of broadcasting messages in the scheduling period according to the updated bit and replaces the plurality of original broadcasting messages with the received broadcasting messages.

The invention will become apparent from the following detailed description of the preferred but non-limiting embodiment. The following description is made with reference to the accompanying drawings.

### BRIEF DESCRIPTION OF THE DRAWINGS

FIG. 1 (Prior Art) is a schematic illustration showing a conventional base station broadcasting message.

FIG. 2 (Prior Art) is a schematic illustration showing the base station broadcasting message 100 being divided and transmitted.

FIG. 3 (Prior Art) is a flow chart showing a conventional method for receiving the messages.

FIG. 4 is a flow chart showing a method for receiving messages according to a preferred embodiment of the invention.

FIG. 5 shows a mobile station according to the preferred embodiment of the invention.

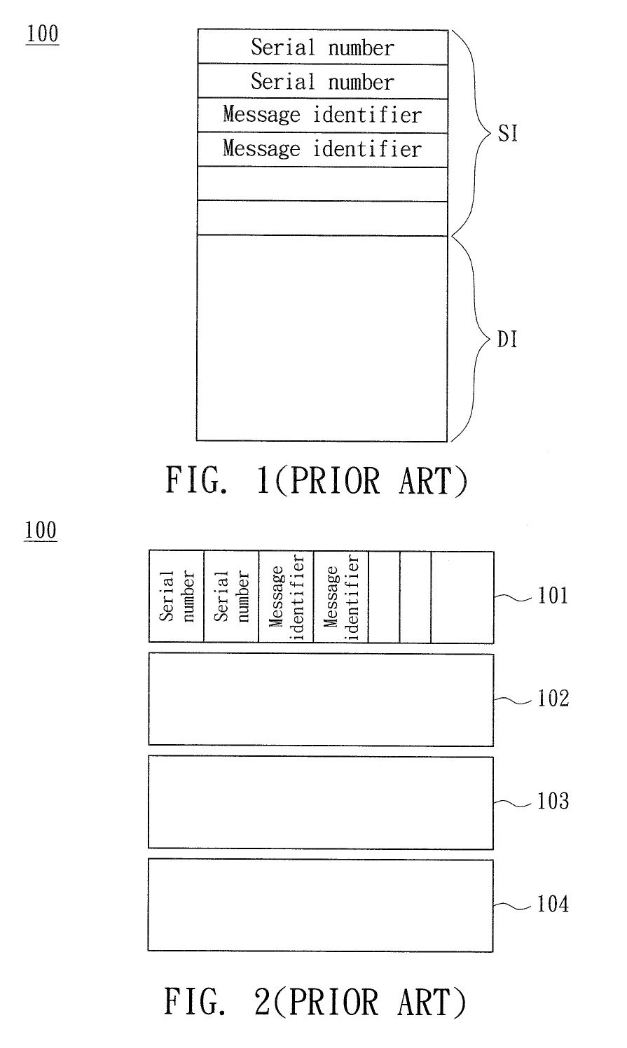

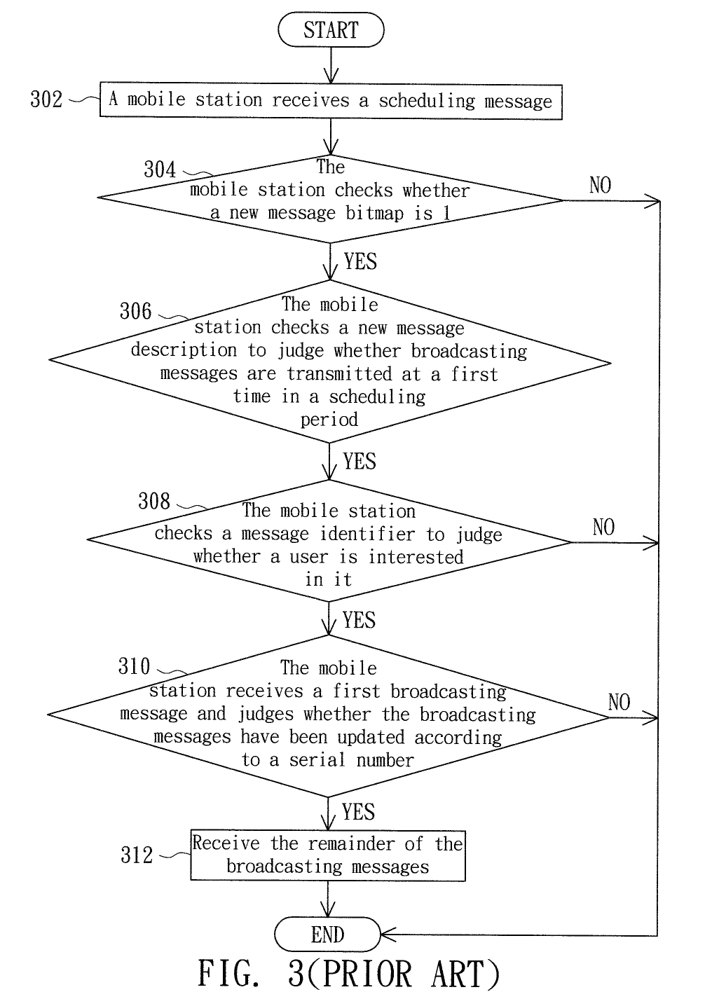

### DETAILED DESCRIPTION OF THE INVENTION

The invention provides a method for receiving messages and a mobile station (MS) using the same, wherein an updated bit is added to a scheduling message, and the updated bit provides the mobile station more detailed information of continuously transmitting broadcasting messages in the following scheduling period. Thus, the mobile station determines whether to receive the broadcasting messages or not to reduce the power consumption and shorten the standby time. The mobile station includes a storing unit, a receiving unit and a control unit. The storing unit stores a plurality of original broadcasting messages. The receiving unit receives the scheduling message. The control unit controls the receiving unit to selectively receive the plurality of broadcasting messages according to the updated bit in the scheduling period and replaces the plurality of original broadcasting messages with the received broadcasting messages.

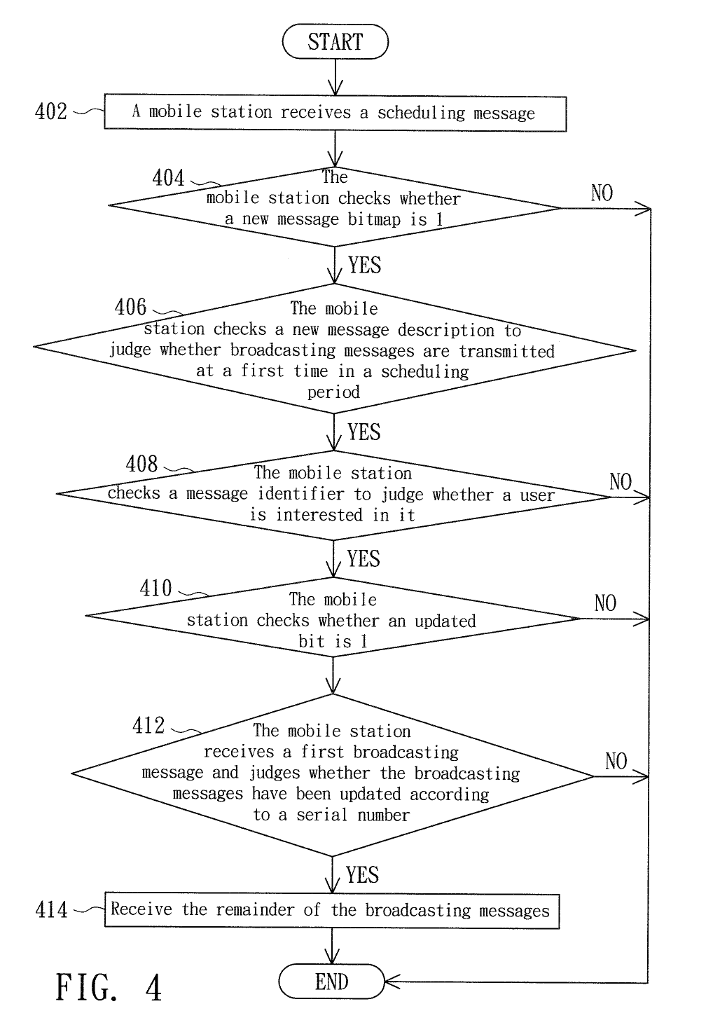

FIG. 4 is a flow chart showing a method for receiving messages according to a preferred embodiment of the invention. In general, a base station controller (BSC) first transmits a base station broadcasting message to a base station, which divides the base station broadcasting message into several broadcasting messages and transmits the divided broadcasting messages to a mobile station. Before the base station transmits the divided broadcasting messages to the mobile station, the base station first transmits the scheduling message to the mobile station to provide the information of the broadcasting messages, that will be transmitted immediately, to the mobile station.

First, in step 402, a receiving unit of the mobile station receives the scheduling message broadcasted from the base station. The scheduling message has a scheduling period, a new message bitmap and an updated bit. The scheduling message includes information of the broadcasting messages that will be continuously transmitted immediately. The time length covered by the broadcasting messages is the scheduling period of the scheduling message. In addition, a storing unit of the mobile station stores several original broadcasting messages, which are transmitted from the base station to the mobile station in a previous scheduling period.

Next, in step 404, the mobile station checks whether the new message bitmap in the scheduling message is 1. That is, the mobile station checks whether the base station transmits the broadcasting messages in the scheduling period. When the new message bitmap is not 1, the base station does not transmit the broadcasting messages subsequently, and the mobile station ends the operation of receiving the messages. When the new message bitmap is 1, the procedure enters step 406, in which the mobile station checks a new message description of the scheduling message to judge whether the subsequently transmitted broadcasting messages are transmitted from the base station at the first time in the scheduling period. When the broadcasting messages are not transmitted in the scheduling period at the first time, it represents that the mobile station has received the broadcasting messages in this scheduling period, and the mobile station ends the operation of receiving the messages.

If the broadcasting messages are transmitted at the first time in the scheduling period, the mobile station checks a message identifier in the new message description in step 408 to judge whether the user is interested in the broadcasting messages or not. When the mobile station judges that the user is not interested in the broadcasting messages, the mobile station ends the operation of receiving the messages.

When the mobile station judges that the user is interested in the broadcasting messages, the mobile station checks whether the updated bit in the scheduling message is “1” in step 410. When the broadcasting messages are different from the original broadcasting messages, the base station changes the updated bit of the transmitted scheduling message during the transmission and sets the updated bit as “1”. When the broadcasting messages are the same as the original broadcasting messages, the base station sets the updated bit as “o”.

When the mobile station has checked that the updated bit is “0”, the mobile station ends the operation of receiving the messages. When the mobile station has checked that the updated bit is “1”, the mobile station receives a first broadcasting message in the broadcasting messages and judges whether the broadcasting messages have been updated according to a serial number of the first broadcasting message in step 412. When the serial number is in a holding state, which represents that the broadcasting messages are in the non-updated state, the mobile station neglects the remainder of the broadcasting messages and ends the operation of receiving the messages. When the serial number is in an updated state, which represents that the broadcasting messages are new broadcasting messages, the mobile station receives the remainder of the broadcasting messages and combines the first broadcasting message with the remainder of the broadcasting messages into the complete base station broadcasting message in step 414.

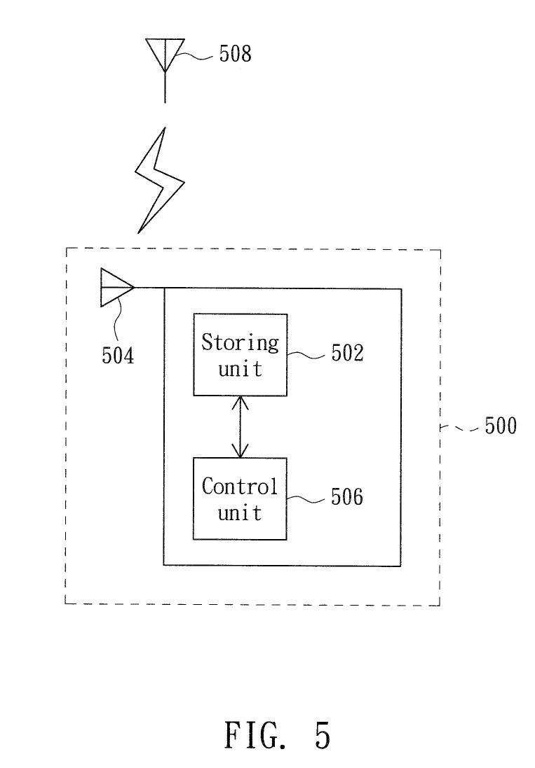

FIG. 5 shows a mobile station 500 according to the preferred embodiment of the invention. Referring to FIG. 5, the mobile station 500 includes a storing unit 502, a receiving unit 504 and a control unit 506. The storing unit 502 stores several original broadcasting messages, which are transmitted to the mobile station 500 from a base station 508 in a previous scheduling period. The receiving unit 504 receives the scheduling message having the scheduling period, the new message bitmap and the updated bit, and providing the information of the broadcasting messages, that will be transmitted immediately, to the mobile station.

The control unit 506 controls the receiving unit 504 to selectively receive the broadcasting messages in the scheduling period according to the updated bit of the scheduling message transmitted from the base station 508, and replaces the original broadcasting messages with the received broadcasting messages. The detailed steps may be found in the description with reference to FIG. 4.

In the method for receiving the messages and the mobile station using the same according to the embodiment of the invention, the updated bit is added to the scheduling message, and the updated bit provides the mobile station more detailed information of continuously transmitting broadcasting messages in the following scheduling period. Thus, the mobile station determines whether to receive the broadcasting messages or not. The mobile station may receive the original broadcasting messages, which have been transmitted from the base station to the mobile station in the previous scheduling period. Although the original broadcasting messages are transmitted at the first time in the scheduling period, the base station sets the updated bit as “0” because the original broadcasting messages are not changed. The mobile station neglects the original broadcasting messages, so the power consumption of the mobile station is reduced and the standby time thereof is shortened.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for receiving messages, the method comprising the steps of:
enabling a base station to broadcast a scheduling message, which has a scheduling period and an updated bit;
enabling the base station to broadcast a plurality of broadcasting messages; and
enabling a mobile station (MS) to receive the scheduling messages and determine to selectively receive the plurality of broadcasting messages according to the updated bit in the scheduling period.

2. The method according to claim 1, further comprising the steps of:
enabling the mobile station to store a plurality of original broadcasting messages broadcasted from the base station; and
enabling the base station to change the updated bit when the plurality of original broadcasting messages is different from the plurality of broadcasting messages.

3. The method according to claim 2, wherein when the updated bit is in a holding state, the mobile station neglects the plurality of broadcasting messages.

4. The method according to claim 2, wherein when the updated bit is in an updated state, the mobile station selectively receives the plurality of broadcasting messages in the scheduling period and replaces the plurality of original broadcasting messages with the received broadcasting messages.

5. The method according to claim 2, further comprising the steps of:
enabling a base station controller (BSC) to transmit a base station broadcasting message to the base station;
enabling the base station to divide the base station broadcasting message into the plurality of broadcasting messages, which comprises a first broadcasting message having a serial number; and
enabling the mobile station to receive the first broadcasting message in the scheduling period when the updated bit is in an updated state.

6. The method according to claim 5, wherein when the serial number is in a holding state, the mobile station neglects the remainder of the plurality of broadcasting messages.

7. The method according to claim 2, wherein the base station sets the updated bit as “1” when the plurality of original broadcasting messages is different from the plurality of broadcasting messages, and the base station sets the updated bit as “0” when the plurality of original broadcasting messages is the same as the plurality of broadcasting messages.

8. A mobile station for receiving messages broadcasted from a base station, the base station broadcasting a scheduling message and a plurality of broadcasting messages, the scheduling message having a scheduling period and an updated bit, the mobile station comprising:
a storing unit for storing a plurality of original broadcasting messages;
a receiving unit for receiving the scheduling message; and
a control unit for controlling the receiving unit to selectively receive the plurality of broadcasting messages according to the updated bit in the scheduling period and replacing the plurality of original broadcasting messages with the received broadcasting messages.

9. The mobile station according to claim 8, wherein when the plurality of original broadcasting messages is different from the plurality of broadcasting messages, the base station changes the updated bit.

10. The mobile station according to claim 9, wherein when the updated bit is in a holding state, the mobile station neglects the plurality of broadcasting messages.

11. The mobile station according to claim 9, wherein when the updated bit is in an updated state, the control unit controls the receiving unit to selectively receive the plurality of broadcasting messages in the scheduling period and replaces the plurality of original broadcasting messages with the received broadcasting messages.

12. The mobile station according to claim 9, wherein a base station controller (BSC) transmits a base station broadcasting message to the base station, the base station divides the base station broadcasting message into the plurality of broadcasting messages, which comprises a first broadcasting message having a serial number, the control unit controls the receiving unit to receive the first broadcasting message in the scheduling period when the updated bit is in an updated state, and the mobile station neglects the remainder of the plurality of broadcasting messages when the serial number is in a holding state.

13. The mobile station according to claim 9, wherein the base station sets the updated bit as “1” when the plurality of original broadcasting messages is different from the plurality of broadcasting messages, and the base station sets the updated bit as “0” when the plurality of original broadcasting messages is the same as the plurality of broadcasting messages.
